(19) United States
(12) Patent Application Publication
(10) Pub. No.: US 2011/0250417 A1
(43) Pub. Date: Oct. 13, 2011

(54) Dimensional Lumber Structural Substitute

(76) Inventors: David Allen Hubbell, Ft. Walton Beach, FL (US); Jerome D. Campbell, Heflin, AL (US)

(21) Appl. No.: 12/755,731

(22) Filed: Apr. 7, 2010

(51) Int. Cl. B32B 3/26

(52) U.S. Cl. 428/218

(57) ABSTRACT

Dimensional lumber subjected to structural load regimes, where moment is the dominate load condition, usually fail structurally by initial localized compressive failure located at or near the maximum compressive extreme fiber. Said localized compressive failure, exhibited by buckling failure of maximum compressive fiber, results in an overall increase of section-modulus. The increase in section modulus, due to onset of structural failure, allows the lumber element in question to provide post-structural-failure increase in load-carrying-capacity with the trade-off of an increase in load-vs-deflection ratio. Said increase in load-carrying-capacity due to the increase in section-modulus, or thickening of the lumber element continues as an applied load is increased until the lumber element's tensile extreme fiber's capacity is exceeded, at which event the lumber element structurally fails catastrophically. The present invention, unlike previously disclosed compositions, unexpectedly mimics the stiffness and failure-mode structural characteristics of traditional dimensional lumber. A comparison of test data shows the present invention possesses unexpected improved properties that the present art does not have.

### REFERENCES CITED

| | | | |
|---|---|---|---|
| 1,217,369 | February 1917 | Tuschel | 428/106; 106/157.7; 428/311.91; 428/435; 428/438 |
| 1,770,507 | July 1930 | Bemis | 52/443; 52/612 |
| 2,489,373 | November 1949 | Gilman | 260/37 |
| 2,851,389 | September 1958 | Lappala | 428/220; 116/DIG.14; 2/87; 244/142; 244/145; |
| | | | 428/165; 428/341; 428/401; 428/422; 428/480; |
| | | | 428/489; 428/500; 428/513; 428/517; 428/522; |
| | | | 428/77 |
| 3,214,320 | October 1965 | Lappala | 428/134; 116/DIG.14; 383/119; 428/140; 428/213; |
| | | | 428/218; 428/483; 428/522; 428/523 |
| 3,222,237 | December 1965 | Mckelvy | 156/177; 156/179; 156/244.12; 156/244.25; |
| | | | 156/493; 428/110; 428/167; 428/172; 428/521 |
| 4,349,297 | September 1982 | Misenser | 405/221; 182/186.6; 182/222; 405/218 |
| 4,795,666 | January 1989 | Okada, et al. | 428/71; 428/72; 52/309.11; 52/309.4; 52/309.7; |
| | | | 52/309.9; 52/834; 52/DIG.7; 52/DIG.8 |
| 4,997,609 | March 1991 | Neefe | 264/122; 264/115; 264/918 |
| 5,048,448 | September 1991 | Yoder | 114/263; 114/266; 403/381 |
| 5,055,350 | October 1991 | Neefe | 428/331; 238/54; 238/84; 238/85; 238/92; 428/403; |
| | | | 428/404; 428/407; 523/139 |
| 5,212,223 | May 1993 | Mack, et al. | 524/318; 521/143; 521/74; 524/300; 524/424 |
| 5,298,214 | March 1994 | Morrow et al. | 264/211.12; 264/331.17; 264/349; 264/911; |
| | | | 425/DIG.46; 525/246 |
| 5,539,027 | July 1996 | Deaner et al. | 524/13; 524/16; 428/338; 428/339; 52/309.1; |
| | | | 52/309.7 |
| 5,613,339 | March 1997 | Pollock | 52/836; 114/263; 114/84; 114/85; 52/177; 52/220.5 |
| 5,728,330 | March 1998 | Erwin, et al. | 264/40.7; 264/148; 264/45.9; 264/46.6 |
| 5,789,477 | August 1998 | Nosker, et al. | 524/494; 428/384; 428/903.3; 521/40.5; 521/41; |
| | | | 523/204; 523/214; 523/513; 523/527; 524/23; |
| | | | 524/493 |
| 5,887,331 | March 1999 | Little | 29/509; 29/525.01; 52/480; 52/650.3 |
| 5,972,475 | October 1999 | Beekman | 428/167; 428/120; 428/178; 428/188; 52/793.1 |
| 6,191,228 | February 2001 | Nosker et al. | 525/240; 525/241; 238/84; 238/85; 238/106 |
| 6,226,944 | May 2001 | Peshkam | 52/309.8; 52/309.1; 52/582.1; 52/586.1; 52/630; |
| | | | 52/834; 52/847 |
| 6,233,892 | May 2001 | Tylman | 52/309.12; 52/309.5; 52/309.7; 52/408; 52/588.1; |
| | | | 52/783.11; 52/794.1; 52/798.1 |
| 6,367,208 | April 2002 | Campbell et al. | 52/169.13; 52/170; 52/301; 52/309.16; 52/721.2; |
| | | | 52/736.1 |
| 6,409,433 | June 2002 | Hubbell et al. | 405/250; 405/231; 52/223.4; 52/723.1; 52/736.3 |
| 6,497,956 | December 2002 | Phillips et al., | 428/376; 264/913; 264/920; 523/200; 523/205; |
| | | | 523/214; 523/217 |

U.S. patent application No. 20050170166, filed Aug. 4, 2005, by Bacon et al.
U.S. patent application No. 20070045886, filed Mar. 1, 2007, by Johnson
Design Of Concrete Structures, Urquhart & O'Rourke, published by McGraw-Hill Book Company, © 1923
Stability Of Structures, Elastic, Inelastic, Fracture, and Damage Theories, Bazant & Cedolin, published by Dover Publications, Inc., © 1991

### SUMMARY OF THE INVENTION

From the foregoing disclosure and the following more detailed description of various preferred embodiments it will be apparent to those skilled in the art that the present invention provides a significant advance in the technology of dimensional lumber structural substitutes.

The present invention provides selective case structural composite application alternatives to traditional structural dimensional lumber utilizing structural-foams/structural-fibers/inorganics matrices.

The present invention relates to dimensional lumber composites and similar load carrying structural elements. Dimensional lumber composites and/or load carrying similar structural element design advancing the present art are required to address the following engineering characteristics:
a) Components that don't rust, corrode, or decompose when exposed to fresh water and/or sea water and/or sewage and/or water-borne creatures, plants, bugs or other such,
b) Does not require special handling equipment on the job-site,
c) Ease of transport to job-site,
d) Ease of handling and rigging, in marine and other similar applications, structural element sections, such as, but not limited to, dimensional lumber composites, should float,
e) Requires no new expensive installation equipment,
f) Quick field jointing of structural element sections, such as, but not limited to, dimensional lumber composites,
g) Structural element sections, such as, but not limited to, dimensional lumber composites, design and construction by components certified and in use by state agencies and approved for use by Federal and State Agencies,
h) Allows the use of existing dimensional lumber engineering design codes, addresses pertinent engineering design consensus standards and specifications,
i) The structural element sections, such as, but not limited to, dimensional lumber composites, should be equal to standard dimensional lumber fire resistant characteristics.
j) Dimensional lumber composites are geometrically similar in cross-section to the traditional dimensional lumber for which they are intended to be structural substitutes.

The present invention encompasses structural lumber configurations as defined by Bacon which teaches the present art dimensional lumber definitions: (paragraph 0018) “boards”, “beams”, and “publication D9-87, “Standard Terminology Relating to Wood” (1999), issued by the American Society for Testing and Materials (ASTM; www.astm.org).” (paragraph 0019) “nominal”, (paragraph 0021) “beam”, “casing”, “rafter”, “studs”, (paragraph 0022) “stud”, “post”, “column.”, (paragraph 0023) “joists”, (paragraph 0025) “rafter”, (paragraph 0026) “truss”, “crown beam”, “joists”, “beams”, (paragraph 0027) “casing”, (paragraph 0028) “beam”, “stringers”, (paragraph 0029) “studs”, “rafters”, “joists”, “beams”, “posts”, (paragraph 0051) “board”, “beam”, “stud”, “rafter”, “joist”, (paragraph 0052) “board”, “plank”, (paragraph 0053) “plank”, “board”.

The present invention's physical manifestations are expressed as per Bacon in rectangular cross-sections exhibiting rounded corners.

Said physical manifestations consist of: a) structural-closed-cell-&-inorganic matrix center element, b) structural fiber outer element, and c) inorganic element sandwiched between.

### BACKGROUND OF THE INVENTION

The present invention addresses the problem statement taught in U.S. Pat. App. No. 20050170166, filed Aug. 4, 2005, by Bacon et al. (“Bacon”), that (paragraph 0014), “ . . . extruded plastic lumber is not as strong as wood, and is more fragile and difficult to work with than wood. To illustrate these problems, here are some excerpts from the instructions provided by www.governmentsales.com: “Unless structurally reinforced, Recycled Plastic Lumber is NOT recommended for ANY structural applications. It is 5 or 6 times more flexible than wood . . . ”

The present invention is the fruit of more than a decade of methodical, persistent analysis, modeling, and full-scale test engineering investigations regime whose yield of unexpected results have been confirmed by independent testing by numerous accredited American civil engineering universities laboratories and other independent-third-party testing.

The inventors of the present invention have maintained a continuous test series of prototypes of the present invention in reduction to practice experiments since 1997. Some of these prototype test series were conducted at:

E-TECH Testing Labs, of Rocklin, Calif., (2000)

Case Western Reserve University, Cleveland, Ohio, (2001)

Syracuse Casting Labs, Syracuse, N.Y., (2002)

North Carolina State University, Raleigh, N.C., (2003 & 2004)

University of Alabama at Birmingham (UAB), (2006 thru 2010)

Various prototype modes, have been on-test in various extreme climates for the past five (5) years without significant reduction in any utility function vectors. Specific test site locations have provided an environmental condition spectrum range from sub-arctic to sub-tropic.

Dimensional lumber can be separated into two categories based on individual wood species' bio-degradation (a.k.a. “rot”) resistance. As a general statement, structurally strong, commercially available, wood species, such as southern-yellow-pine (SYP) tend to be highly susceptible to “rot”, while less strong species tend to be “rot resistant” such as white cedar.

Structural lumber preservative means-and-methods, such as 19^{th} century “creosote” formulas or the mid-20th century “CCA” treatments are, for the most part, considered environmental pollution vectors and are now banned by Federal regulations and many State statutes and regulations.

The few rot-resistance species with reasonable structural strength, such as “red wood” or “western red cedar”, were not part of the recent decades' forestry-farm planning, or sustainable-forestry-management, in any significant quantities. As such, market prices for these naturally rot-resistant wood species are climbing at much higher rates than average lumber prices.

The Federal and State required phase-out of CCA-treated lumber is in its final stages. The current, EPA accepted wood treatment technologies have failed to provide rot-protection even close to the now-unacceptable CCA treatments. In fact, recent multi-year in-field full-scale testing has shown that the new EPA accepted wood treatments provide less than ¼ the life-cycle provided by the older standard CCA treatments.

This failure of the present EPA acceptable wood lumber treatments presents the industry with a short-time-horizon as older, in-situ, CCA-treated lumber and the new treated lumber reach end-of-service-life-cycles together.

The industry is now conscious of this pending lumber application crisis. To date, there are no commercially available substitute products for traditional, treated, dimensional lumber, which provide strength and stiffness characteristics similar to high strength, CCA-treated SYP.

Substitutes for traditional dimensional lumber required characteristics are: long, rot-free, service life, comparable pricing, similar weights per cu. ft., similar engineering design unit strengths, with the product able to be utilized, carpentered, handled, with traditional lumbering tools (sawn, cut, drilled) and fastener hardware (nailed, screwed, glued).

The above requirements are met by the present inventors' reduced to practice physical manifestation characteristics of the present invention.

The present invention's economic vitality centers on two aspects:
First, independent, full-scale testing of examples of the present invention's physical expressions show that said examples provide factors-of-magnitudes higher unit strengths than common grades of wood lumber with similar stiffness or load to deflection ratios. As such, modest engineering design efforts will result in significant reductions in the present invention's materials-costs while providing the customer with equivalent product utility.
Second, the present invention's physical manifestations, if engineered to common grade lumber engineering characteristics, is of significantly lower density resulting in lower transportation costs.

Dimensional timber or lumber subjected to moment, or bending moment load or combined load regimes where moment is the dominate load condition, usually fail structurally by initial localized compressive failure located at or near the maximum compressive extreme fiber.

Said localized compressive failure is usually exhibited by buckling failure of said maximum compressive fiber. Such structural behavior directly results in an overall increase of the subjected lumber element's section-modulus.

Assuming a typically encountered dimensioned timber or lumber element, for a given wood species, for a given grade of lumber, the above referenced increase in section modulus due the onset of structural failure, while usually resulting in an increase in the load-vs-deflection relationship, allows the lumber element in question to provide an increase in load-carrying-capacity.

Said increase in load-carrying-capacity due to the increase in section-modulus, or thickening of the lumber element continues as an applied load is increased until the lumber element's tensile extreme fiber's capacity is exceeded, at which event the lumber element structurally fails catastrophically.

Similar structural aspects are in play involving hardware fastener applications to dimensional timber or lumber such as screws, bolts and nails except that shear is usually an initial structural failure mechanism, where said failure is in the wood material and not the fastener, followed immediately with bending moment carried by the wood fiber located between the point of initial shear failure, usually located at or near the shank of the fastener some distance from the surface of the lumber element.

Such structural failure mode behavior provides some mitigation from catastrophic structural failure when a given fastener/lumber-element connection is loaded beyond its capacity.

The above two (2) references to typically encountered dimensional timber's or lumber's initial non-catastrophic structural behavior explains some of the primary structural engineering reasons for the continued widespread use of dimensional timber of lumber.

Disadvantages in the use of dimensional timber or lumber include traditional problems associated with initial structural quality of any given selection of structural addresses the design, manufacture and assembly of eccentrically load bearing columns.

### PRESENT ART

The present art rests on a broad foundation of publications, issued U.S. patents' and patent applications' teachings.

Examples of publications utilized by the present inventions, highlighting discussions relevant to the present invention, are:

Bazant & Cedolin address such concerns in structural composites (page 741):

“Three-dimensional instabilities are important for solids with a high degree of incremental anisotropy, which can be either natural, as is the case for many fiber composites and laminates, or stress-induced, as is the case for highly damaged states of materials. The typical three-dimensional instabilities are the surface buckling and internal buckling, as well as bulging and strata folding.”

(page 746):

“ . . . three dimensional buckling modes described . . . no doubt play some role in the final phase of compression failures. For example, Bazant (1967) showed that a formula based on . . . thick-wall buckling . . . agrees with his measurements of the effects of the radius-to-wall thickness ratio on the compressive failure stress of fiber-glass laminate tubes. On the other hand, other physical mechanisms, particularly the propagation of fractures or damage bands, are no doubt more important for the theory of compression failure. The reason is two-fold: (1) The calculated critical states for the three-dimensional instabilities require some of the tangential moduli to be reduced to the same order of magnitude as some of the applied stress components, which can occur only in the final stage of the failure process; and (2) the body at this stage might no longer be adequately treated as a homogeneous continuum.”

(page 750):

“ . . . orthotropic composites that have a very high stiffness in one direction and a small shear stiffness may suffer three-dimensional instabilities such as internal buckling or surface buckling. These instabilities, which involve buckling of stiff fibers (glass, carbon, metal) restrained by a relatively soft matrix (polymer), are analogous to the buckling of perfect columns. When the fibers are initially curved, one may expect behavior analogous to the buckling of imperfect columns. In particular, the initial curvature of fibers causes fiber buckling, which reduces the stiffness of the composite. It also gives rise to transverse tensions, which may promote delamination failure.”

Urquhart & O'Rourke, in their 1923 text, address the general nature of Bazant & Cedolin's concerns regarding composite structures' “ . . . three-dimensional instabilities . . . ”. (page 163):

“Whenever a material is subjected to compression in one direction, there will be an expansion in the direction perpendicular to the compression axis. When this expansion is resisted, lateral compressive stresses are developed, which tend to neutralize the effect of the longitudinal compressive stress, and thus increase resistance against failure. This is the principle involved in the use of spiral or hoped reinforcement . . . . Within the limit of elasticity the hoped reinforcement is much less effective than longitudinal reinforcement, Such reinforcement, however, raises the ultimate strength of the column, because the hoping delays ultimate failure . . . ” The material “ . . . continues to compress and to expand laterally, thus increasing the tension in the bands, while final failure occurs upon the excessive stretching or breaking of the hoping.” “As long as the bond between the . . . ” fiber and the polymer “ . . . is effective, the two materials will deform equally, and the intensities of the stresses will be proportional to their moduli of elasticity.”

A structural system's failure mode can be defined as the characteristics bounded by that known as “catastrophic” or “localized” within the said system, wherein the term “catastrophic” indicates a system-wide structural failure involving progressive individual and sub-systemic structural element(s) failures and the term “localized” indicates a system or sub-system arrest of structural failure and/or redistribution of the force(s) which resulted in the initial failure-mode of the initial failed structural element.

One of the unexpected results of full-scale testing of the present invention's physical manifestations, now confirmed, is the damping effect of the present invention to structural “shock”, a characteristic similar to that of large dimensional lumber.

The following selected U.S. patent and U.S. patent application excerpts provide an overview of the present art relative to the present invention:

U.S. Pat. No. 1,770,507, issued Jul. 15, 1930, to Bemis, which teaches of (page 1, line 1) “ . . . an improved form of building material which may be conveniently termed synthetic lumber and may be provided either in sheets of any desired dimensions to form a substitute for . . . ordinary wall board, or in thicker sections may be substituted for boards . . . which are designed to form portions of walls, floors or roofs and are required to have a moderate degree of structural strength.” (page 1, line 13) “The invention more particularly pertains to the formation of composite lumber from sheets or laminations of fibrous material . . . and frangible plastic . . . ” (page 1, line 36) “The present invention by combining the characteristics of the separate materials indicated above provides a building material which has the advantages common to both of the types of material previously used, with the disadvantages thereof reduced in degree or eliminated, thus suited to a wide range of uses. The synthetic lumber disclosed herein, which comprises fiber . . . located at either side of a frangible core, has comparatively good tensile and bending strength as well as a satisfactory degree of compressive strength and does not have an objectional tendency to swell or wrap under conditions of high humidity. Preferably the fiber . . . is provided with a rough, irregular, or semi-villous surface whereby it may be firmly bound to the . . . core . . . ” (page 1, line 56) “In proportion to its strength and moisture resistant qualities it is comparatively light and may provide very good heat insulation, while having better nailing qualities . . . ” (page 1, line 99) “ . . . preferably pressure is . . . applied to insure intimate bonding of the fibers and the plastic material.”

U.S. Pat. No. 3,616,130 (130), issued Oct. 26, 1971, to Rogosch et al. teaches that (col. 1, line 16) “(s) heets of flexible, reinforced laminated plastic material are finding increasing use in a wide variety of applications today. The advent of low-cost thermoplastic material, e.g., polyethylene has increased the use of reinforced polyethylene . . . ” (col. 1, line 32) “Among patents disclosing reinforced thermoplastic material and methods for their manufacture are U.S. Pat. Nos. 2,851,389; 3,214,320; and 3,222,237.” (col. 4, line 61) “ . . . high strength can be gained from the use of monofilament and multifilament glass fibers either woven or nonwoven.”

U.S. Pat. No. 5,539,027, issued July, 1996 to Deaner et al., teach that (Col. 2, Line 17) a substantial need exists for the development of a composite material that can be directly formed by extrusion into shapes that are direct substitutes for the equivalent or corresponding shape in a wood structural member. The need requires a modulus (stiffness), an acceptable coefficient of thermal expansion and an easily formable able material that can maintain reproducible stable dimensions, a material having low thermal transmission, improved resistance to insect attack and rot while in use and a material that can be cut, milled, drilled and fastened at least as well as wooden members.

U.S. Pat. No. 5,613,339, issued Mar. 25, 1997, to Pollock, teaches that (col. 1, line 22) “(i)n the past, the conventional dock construction technique was to use wooden joints and frame members of 2×6, 2×8, or 2×10 lumber, or the like. The deck planks were conventionally 2×6 or 2×8 lumbers fastened to the top surfaces of the joists with a slight gap (e.g., ¼ to ½ inch) between adjacent deck planks to permit water to ready drain from the deck. However, wooden deck planks, even when pressure treated lumber is used, tend to deteriorate over time, especially when exposed to the constantly wet environment of a boat dock and when the dock is on a body of salt water. In addition, pressure treated lumber is difficult to paint and some persons object to the natural “greenish” color of most pressure treated lumber. There is also a concern that the preservative used to treat pressure treated lumber may leach out of the lumber and contaminate the water surrounding a dock made of such pressure treated lumber.” (col. 1, line 39) “Deck planks of materials other than wood, including polyvinyl chloride, have been used, but all of these prior alternative deck plank materials have had their shortcomings.” (col. 1, line 46) “Misenser, U.S. Pat. No. 4,349,297 describes a boat dock in which plastic resin planks” (col. 1, line 49) “U.S. Pat. No. 5,048,448 to Yoder discloses a boat dock structure including an elongate plank of extruded PVC plastic or the like . . . ” Higher grades of structural lumber or dimensional timber or lumber have increasingly become scarce, expensive, and in larger dimensions, simply unavailable. Market forces have encouraged the introduction of alternative materials for traditional wood timber or lumber applications. These alternatives, when direct substitutions have been attempted using, as taught by U.S. Pat. No. 5,887,331(331) issued Mar. 30, 1999 to Little, (col. 1, line 13) “(t)he same construction techniques used with wood lumber have been used in . . . construction . . . out of polymer plastic lumber, with disastrous results. Unlike wood lumber, polymer plastic lumber experiences wide variations in length with variations in temperature. A 16 foot length of polymer plastic lumber may experience a variation in length of as much as 2 inches. During the coldest day of winter the polymer plastic lumber will have a length of 15 feet 11 inches. During the warmest day of summer the polymer plastic lumber will have a length of 16 feet 1 inches. This thermal expansion and contraction has the effect of pulling out fasteners and buckling materials.”

U.S. Pat. No. 6,191,228, issued Feb. 20, 2001, to Nosker et al., teaches that the (col. 1, line 64) “ . . . material also has to be suitable for use with typical types of fasteners, such as those used for wood materials, e.g., nails, screws, spikes, bolts, etc.” (col. 2, line 2) “While wood is a relatively inexpensive material, it is very susceptible to attack from microorganisms such as fungi and insects, which will weaken and deteriorate. To compensate for this . . . chemically treated to resist such attacks. Examples of such chemical treatments are creosote treatment and chromate/copper/arsenic treatment. These treatments greatly increase costs. Further, chemical treatments only delay attack, not prevent it.” (col. 2, line 48) “ . . . plastic polymers and plastic composite materials offer a viable alternative to wood . . . . Manufactured plastics composites can exhibit the necessary stiffness strength, resistance to heat expansion and deformation, as well as increased resistance to degradation from moisture, excessive sunlight and attacks by microorganisms and insects.” (col. 2, line 62) “However, the cost of raw materials is a disadvantage of plastic polymers and plastic composites. Virgin polymer resins can be quite expensive thereby making their use economically unfeasible.” (col. 2, line 66) “Still attempts have been made to manufacture general replacement lumber from plastics and plastic composites.” (col. 3, line 1) “Trimax . . . manufactures a lumber substitute made from a stiff plastic composite material made of fiberglass and high density polyethylene (HDPE). A typical lumber product made solely of HDPE has a relatively high compression strength of about 3,000 psi, but has a low stiffness . . . ” (col. 3, line 8) “In comparison to HDPE alone, the Trimax material has a higher stiffness . . . but a lower strength (compression strength of about 2,000 psi)” (col. 3, line 12) “Eaglebrook Products Inc. also manufactures a synthetic lumber substitute. The material is made from relatively pure HDPE and, therefore, exhibits a comparatively low compression modulus and a relatively high coefficient of thermal expansion.” (col. 3, line 21) “Neefe, U.S. Pat. Nos. 4,997,609 and 5,055,350, use compression molding to manufacture a composite railroad tie from sand and granulated recycled plastics. These two components are held together by an adhesive coating material, i.e., sugar or polystryrene.” (col. 3, line 26) “A recent patent, Nosker et al. (U.S. Pat. No. 5,789,477), incorporated herein by reference, describes the requirements of materials used for railroad ties . . . . As a substitute material, Nosker et al. disclose a composite made from coated fibers, such as fiberglass or carbon fibers, distributed within a polymer component containing about 80-100% high density polyethylene (HDPE) The polymer component can be made from recycled plastics.” (col. 4, line 51) “As described in, for example, Morrow et al. U.S. Pat. No. 5,298,214, hereby incorporated by reference, polystyrene can be bended with a “mixed plastics” component from a recycling stream to produce materials that behave mechanically and appear morphologically like fiber reinforced composites.” (col. 5, line 56) “Material in accordance with the Morrow process is being manufactured as plastic lumber by Polywood Inc. for use as, e.g., decking, walkways, fencing, posts and docks. While the strength of this material makes it an excellent candidate as substitute lumber, it is susceptible to corrosion from some organic solvents. For the example, due to its high polystyrene content and the three dimensional structure formed therefrom, the material is not suitable for use in areas were exposure to organic solvents like gasoline is probable. Polystrene will dissolve when contacted with gasoline. Due to the three dimensional network of the polystyrene component, once gasoline has contacted the material it will penetrate into the interior and weaken the entire composite.”

U.S. Pat. No. 6,497,956 (956) issued Dec. 24, 2002, to Phillips et al., teaches that of (col. 1, line 18) “ . . . high density polyethylene (HDPE) . . . ” and that (col. 1, line 28) “ . . . plastic lumber made from HDPE, PVC, PP, or virgin resins has been characterized as having insufficient stiffness to allow its use in structural load-bearing applications.” (col. 1, line 33) “For example, it is noted that non-reinforced plastic lumber products typically have a flexural modulus of only one-tenth to one-fifth that of wood such as Douglas fir,” (col. 1, line 37) “ . . . U.S. Pat. No. 5,212,223 discusses the inclusion of short glass fibers within reprocessed polyolefin and further teaches doing so to increase the stiffness of the nonreinforced plastic lumber by a factor of 3:4. However, none of the prior art known to applicant is capable of fabricating plastic lumber having the structural stiffness and strength of products made according to the present invention . . . ”

U.S. Pat. App. No. 20070045886, filed Mar. 1, 2007, by Johnson teaches that (paragraph 0009) “ . . . composite lumber is currently used for decking, railing systems and playground equipment. Sources indicate that there currently exists a $300 million per year market for composite lumber in the United States. It is estimated that 80% of the current market uses a form of wood plastic composite (WPC). It is estimated that the other 30% is solid plastic. A wood plastic composite (WPC) refers to any composite that contains wood particles mixed with a thermaloset or thermoplastic. The WPC industry uses common wood species related to their region for the United States including pine, maple, oak and others. Particle sizes that are typically incorporated into WPC's range from 10 to 80% mesh. The presence of wood fiber increases the internal strength and mechanical properties of the composite as compared to, e.g., wood flower. WPC uses approximately 20% to 70% by mass wood to plastic ratios in a typical manufacturing process.” (paragraph 0010) “WPC's have desirable characteristics as compared to plastic systems. For example, the addition of wood fillers into plastic generally improves stiffness, reduces the coefficient of thermal expansion, reduces cost, helps to simulate the feel of real wood, produces a rough texture improving skid resistance, and allows WPC to be cut, shaped and fastened in a manner similar to wood.” (paragraph 0011) “The addition of wood particles to plastic also results in some undesirable characteristics. For example, wood particles may rot and are susceptible to fungal attack, wood particles can absorb moisture, wood particles are on the surface of a WPC member can be destroyed by freeze and thaw cycling, wood particles are susceptible to absorbing environmental staining, e.g., from tree leaves, wood particles can create pockets if improperly distributed in a WPC material, which may result in a failure risk that cannot be detected by visual inspection, and wood particles create manufacturing difficulties in maintaining consistent colors because of the variety of wood species color absorption is not consistent. Plastics use UV stabilizers that fade over time. As a result, the wood particles on the surface tend to undergo environmental bleaching. Consequently, repairing a deck is difficult due to color variation after 6 months to a year of sun exposure.” (paragraph 0012) “In a typical extrusion composite design, increased load bearing capacity capability may be increased while minimizing weight by incorporating internal support structures with internal foam cores. Examples of such designs are taught in U.S. Pat. Nos. 4,795,666; 5,728,330; 5,972,475; 6,226,944; and 6,233,892.” (paragraph 0013) “Increased load bearing capacity, stability and strength of non-extruded composites has been accomplished by locating geometrically shaped core material in between structural layers. Examples of pre-formed geometrically shaped core materials include hexagon sheet material and lightweight woods and foam. Problems associated with typical preformed core materials include difficulties associated with incorporating the materials into the extrusion process due to the pre-formed shape of the materials.” (paragraph 0014) “Other efforts to increase strength with composite fiber design have focused on fiber orientation in the composite to obtain increased strength to flex ratios. In a typical extrusion composite process, the fiber/fillers are randomly placed throughout the resin/plastic. Therefore increasing strength by fiber orientation is not applicable to an extrusion process.” (paragraph 0015) “Foam core material has been used in composites for composite material stiffening, e.g., in the marine industry, since the late 1930's and 1940's and in the aerospace industry since the incorporation of fiber reinforced plastics.” (paragraph 0016) “Recently, structural foam for core materials has greatly improved in strength and environmental stability. Structural core material strengths can be significantly improved by adding fibers. Polyurethane foams can be modified with chopped glass fibers to increase flexible yield strength from 8,900 psi-62,700 psi.” (paragraph 0017) “Prior art patents tend to describe foam core materials as rigid or having a high-density. However structural mechanical properties of the foam core tend not to be addressed. A common method to obtain a change in load capacity is to change the density of the material. For example, this can be done in a polyurethane in which water is being used as a blowing agent. The density of a polyurethane decreases with the increase in water concentration.” (paragraph 0018) “One problem that may occur when a core material and a structural material are not compatible both chemically and physically is delamination. Chemical and physical incompatibility can result in composite structures that suffer structural failures when the core material and the structural material separate from one another.” (paragraph 0022) “ . . . coefficient of thermal expansion (CTE) . . . . ” (paragraph 0025) “The conformable core material is injected into and around internal structural support members of an extruded member. Preferably, while the member is being extruded, the core material is injected to replace air voids within the member. The injection of conformable structural core material at the same time and same rate as the structural member is being extruded produces significant improvements by increasing load bearing capacity, stability and overall strength and by improving economic feasibility. For example, a rigid polyurethane foam is approximately 10 times less expensive per volume than PVC. Therefore, by replacing some interior volume of an extruded member with foam, the PVC volume is reduced while maintaining the same structural strength or greater. Therefore, the injection of a conformable foam results in a significant cost savings. In some applications, the injectable conformable structural core material may be applied to an extruded member that has been previously cured.” (paragraph 0026) “One benefit of an injectable conformable structural core material is that the core material is not limited by the structural design of the composite member because the core material conforms to the geometric shapes present in structure.” (paragraph 0027) Although a core material and a structural material may be initially combined into a composite member without regard to the CTE's of each, this does not guarantee structural integrity over time. Therefore, the invention of the application involves tailoring of the conformable structural core material by the selection of optimal amounts of structural fillers to achieve a desired CTE of the materials. The step of tailoring the structural core material provides a solution for composite structural design regardless of the composition of the materials.” (paragraph 0028) “One aspect of the invention is directed towards the mechanical interaction and the relationship between a selected thermal plastic and a selected foam core material. Thermal plastics have mechanical properties that are influenced by environmental temperatures. For example, thermal plastics are stronger at colder temperatures but are more brittle. Thermal plastics are weaker in warmer weather, but are more flexible.” (paragraph 0029) “Foam for an internal core material inside a thermal plastic material may be tailored to overcome variations in structural strengths of thermal plastics. For example, an ideal core material is selected to possess thermal expansion properties that offset the thermal sag characteristics of thermal plastic structural material that the structural material experiences due to thermal heating in the environment. The thermal expansion of the core and mechanical stiffness of the composite may be tailored to achieve desired strength and internal pressure, resulting in mechanical stiffening of the composite.” (paragraph 0030) “The interaction of thermal sag of the thermal plastic material in relationship to the thermal expansion of the internal core material may be considered to select an ideal foam for use with a particular plastic. Ideally, the materials will function as a true composite. Because of the enormous uses of this invention associated with composite design and their applications with the overwhelming selection of materials and their combinations, the method described herein allows for optimal material pairings to be determined. As internal cross members of a structural member and the exterior structure undergo mechanical weakening as the temperature increases, a selected internal core material having an optimal thermal expansion with enhanced thermal mechanical properties will improve the rigidity and the mechanical strength of the combined composite in a manner similar to inflating an automobile tire to increase mechanical rigidity of the rubber.” (paragraph 0031) “A further advantage associated with the use of core materials such as foams are thermal insulation properties of the foam. A significant mechanical advantage is achieved by reducing the heat transfer rate from the surface of a structural member to an internal support structure of the composite, thereby thermally shielding the internal support structure from heat fluctuations and maintaining increased internal strengths of the cell structures in the composite during elevated temperatures.” (paragraph 0032) “CTE can be tailored in a composite matrix to improve surface functionality between the structural material and the core, thereby reducing the shear stresses that are created by thermal cycling at the contact interface of the two materials. Polyurethane foam densities are directly proportional to the blowing agent, typically water. The less water, the tighter the cell structure, which results in higher density foams.” (paragraph 0033) In a closed cell structure, controlling internal forces caused by thermal cycling produced by the core material can be accomplished by tailoring the CTE. The CTE of a core material may be tailored by adjusting an amount of filler in the core material. For example, fillers such as chop fibers and micro spheres will have much lower CTE in the structural foam. The CTE of glass spheres is approximately 100 times smaller than most resin materials.” (paragraph 0034) “Glass spheres or ceramic spheres have enormous compression strength in comparison to the foam cells created by blowing agents. Therefore, the addition of micro spheres will not only provide the ability to tailor the CTE of the foam but it will replace low compression strength cell structures with higher strength cell structures.” (paragraph 0035) “The incorporation of chop fibers adds dramatic cross structural strength throughout the foam. Applicant's mechanical model analysis clearly illustrates an increased strength of materials resulting from the presence of core material regardless of the mechanical structure. The analysis was directed to extruded PVC. Some of the extruded PVC members were filled with chopped fibers and some were not. The chopped fibers increased strength of the structural member and decreased the CTE. The additives of selected fillers to the foam core materials illustrate similar characteristics. Selecting appropriate materials for a composite is complicated because composites are not homogeneous materials. However, composites are required to function as a homogeneous structure without structural deviation. The models clearly show how reinforcing fibers increases load bearing capabilities in the composite materials.” (paragraph 0036) “Manmade fibers and fillers can be used to improve mechanical properties as well as to lower CTE's of a core material. Ideally, filler materials should be environmentally stable and manipulatable into desired geometric configurations so that they may be incorporated into a structural design. Examples of fiber materials include fiberglass, carbon and nylon. These fibers can be cut to a specific length with a desired diameter that can be incorporated into an injection molding process either from the plastics manufacturer if the desired material is a foam plastic. If the resin is a reactive material such as polyurethane foam, the fillers and fibers can be combined either in the liquid stage prior to mixing the reactive components or in the foam mixing chamber prior to being extruded. The coefficient of thermal expansion is directly related to the volume fillers to plastics ratio.” (paragraph 0037) “Solid core materials can be made from high-density polyurethane, polyureas and epoxy materials etc., having high strength and fast cure times. These materials may be filled with fillers or micro spheres to produce high strength injectable core materials.”

A comparison of test data shows the present invention possesses unexpected improved properties that the present art does not have.

### BRIEF DESCRIPTION OF THE DRAWINGS

FIG. 1 is a view showing a cross-section in accordance with the present invention.

FIG. 2 is a view showing a longitudinal section in accordance with the present invention.

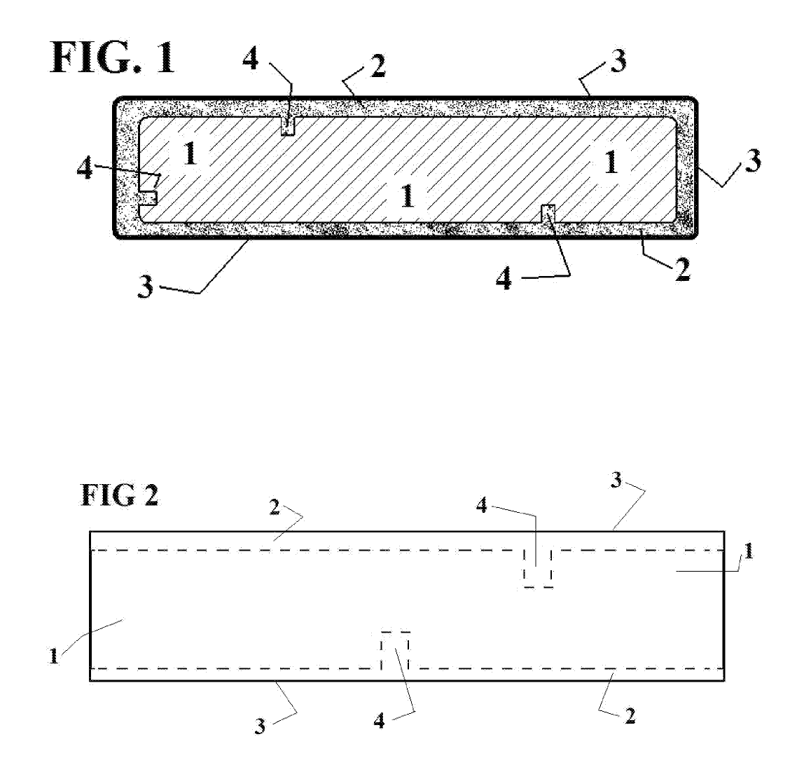

### DETAILED DESCRIPTION OF CERTAIN PREFERRED EMBODIMENTS

The following detailed discussion of various alternative and preferred features and embodiments will illustrate the general principles of the invention with reference to dimensional structural lumber substitutes. Other embodiments suitable for other applications will be apparent to those skilled in the art given the benefit of this disclosure. The particular combination of parts described and illustrated herein is intended to represent only certain embodiments of the present invention.

The present invention's preferred embodiment is:
The present invention's physical manifestations are expressed as per Bacon in rectangular cross-sections exhibiting rounded corners.
Said physical manifestations consist of: a) structural-closed-cell-&-inorganic matrix center element(s), b) structural fiber outer element, and c) inorganic element sandwiched between.
The structural-closed-cell-&-inorganic matrix center element(s) consist of a mix of mica particles and pre-expanded expandable polystyrene structural-closed-cell material and urethane adhesive. Heat and moisture is applied to the mix to construct the invention's center element(s) 1.
The structural fiber outer element consists of two matrices of fiberglass 2, which partly overlap each other.
The inorganic sandwiched element 3, consists of a mica and adhesive mixture.

An alternative preferred embodiment is as described above with the structural-closed-cell-&-inorganic matrix center element(s) partially perforated 4. Said perforations providing for additional placement of the inorganic sandwiched element 3.

It will be apparent to those skilled in the art, that is, to those who have knowledge or experience in this area of technology that many uses and design variations are possible for the dimensional structural lumber substitutes disclosed here.

It is claimed:

1. A first center element(s) construction matrix consisting of a mixture of expandable structural foam, inert material and adhesive, in which the inert material is stratified throughout the center element(s) thickness providing more density of inert material on one side than the other side of the center element's thickness. A second sandwiched element consisting of inert material and adhesive. A third element consisting of a structural outer fiber mats.

2. As in claim 1, wherein said center element(s) surfaces intended to be in contact with the sandwiched element is textured, filled or otherwise profiled before attachment of the sandwiched element.

3. As in claim 1, wherein said resultant structural composite's cross-sectional outer perimeter changes over it's length, and such change negated in load case(s) required section-modulus by change in radius-to-wall thickness ratio via change in the center element(s) thickness.

4. As in claim 1, wherein said inert material is inorganic.

5. As in claim 1, wherein said inert material is organic.

6. As in claim 1, wherein said inert material is mica.

7. As in claim 1, wherein said fiber mat includes fiberglass.

8. As in claim 1, wherein said fiber mat includes carbon-fibre.

9. As in claim 1, wherein said fiber mat includes urethane adhesive.

10. As in claim 1, wherein said sandwiched element's adhesive is urethane.

11. As in claim 1, wherein said first center element(s)' adhesive is urethane.

12. As in claim 1, wherein said first center element(s) contain perforations.
